(19) United States
(12) Patent Application Publication
(10) Pub. No.: US 2010/0311406 A1
(43) Pub. Date: Dec. 9, 2010

(54) Phone Control Device for Remotely Controlling Electric Appliances

(76) Inventor: Hui-Nan LIN, Kaohsiung City (TW)

Correspondence Address: Dr. BANGER SHIA;Patent Office of Bang Shia, 102 Lindencrest Ct., Sugar Land, TX, 77479-5201, US

(21) Appl. No.: 12/493,200

(22) Filed: Jun. 27, 2009

(30) Foreign Application Priority Data
Jun. 3, 2009 (TW) 098209733

(51) Int. Cl. H04M 3/00

(52) U.S. Cl. 455/420

(57) ABSTRACT

A phone control device for remotely controlling electric appliances is capable of wireless and remotely controlling electric appliances by receiving and transact phone signal via phone network, wherein the phone control device sends out feedback signal through the phone network and receives on/off driving signal corresponding to the feedback signal.

### BACKGROUND OF THE INVENTION

1. Field of the Invention

The present invention relates to a remote control device, and more particularly to a phone control device for remotely controlling electric appliances.

2. Description of the Prior Art

With the development of science and technology, nowadays, many electric appliances, such as air conditioner, electric fan, audio accessories, can be controlled in a remote control manner. For example, a phone can be used as a remote control device by being connected to a controller which is connected to an electric appliance via a line. It is inconvenient since the control of the electric appliance requires wire connection.

Taiwan Patent No. 091209792 discloses a power source remote control device which is free of the abovementioned disadvantage and comprises a ring detecting circuit for converting ring into pulse signal, a microprocessor capable of counting the number of the pulses and sending out carry-out signals, a power source control circuit connected to a machine and an external power source for turning on and off the machine based on the received carry-out signals. This power source remote control device can cut off the power to the machine in a short time and can restart the machine by a phone call. The voltage required by the power source remote control device is provided by a power supply circuit.

Taiwan Patent No. 093213558 discloses another power source remote control device which remotely controls the electric appliances by transacting and converting phone signals and comprises a RD-infrared convertor for converting RD (radio frequency) into infrared, a signal processor and a current detecting device. The signal processor converts phone multi-frequency signal into a first control signal and sends it to the convertor which will convert the signal into infrared control signal and sends it to the electric appliance to make it start. The current detecting device detects the startup current and sends out a second control signal to the RD-infrared convertor and the signal processor, letting the RD-infrared convertor and the user confirm (know) the startup condition of the electrical appliance.

### SUMMARY OF THE INVENTION

The primary object of the present invention is to provide a phone control device which is capable of wireless and remotely controlling electric appliances.

To achieve the above object, a phone control device for remotely controlling electric appliances in accordance with the present invention comprises: a ring and echo detector, a key decoder, a data storage device, an on/off hook simulator. The ring and echo detector is electrically connected to a phone network to receive phone signal and also connected to the single chip to convert the phone signal into ring signal. The single chip serves to receive ring signal, record the number of times of the ring signal generated and drive an on/off hook simulator. The key decoder is electrically connected to the phone network and the single chip. The data storage device is electrically connected to the single chip and provides comparison signal. The on/off hook simulator includes an off-hook circuit and an on-hook circuit, the off-hook circuit is electrically connected to and driven by the single chip to simulate an off-hook state, the single chip sends out feedback signals to a user via the ring and echo detector and the phone network, the key decoder catches and decoding control and on/off driving signals corresponding to the feedback signals via the phone network, the single chip compares the comparison signal obtained from the data storage device with the control signal obtained by the key decoder, the single chip serves to remotely control on/off of an electric appliance by a wireless transmitter which is electrically connected to the single chip, the on-hook circuit catches an on-hook signal via the phone network and sends it to the single chip, and the off-hook circuit simulates an on-hook state.

The phone control device for remotely controlling electric appliances in accordance with the present invention has the following advantages:

1. The present invention only needs to learn and save the control code, and the user can do wireless remote control at any time, any place by using telephone or mobile phone, without requiring additional equipments, as long as he knows the control code, so that cost is lowered.

2. The present invention can carry out wireless remote control without using cable, so that the cost is further reduced.

3. The present invention adopts the wireless remote control method, so it is free of the direction problem of the infrared signal generator, namely, the electric appliance can be controlled by the control device at any direction.

### BRIEF DESCRIPTION OF THE DRAWINGS

FIG. 1 is an illustrative view of a phone control device for remotely controlling electric appliances in accordance with the present invention; and

FIG. 2 is an illustrative view showing the phone control device in accordance with the present invention and the electric appliances.

### DETAILED DESCRIPTION OF THE PREFERRED EMBODIMENT

The present invention will be clearer from the following description when viewed together with the accompanying drawings, which show, for purpose of illustrations only, the preferred embodiment in accordance with the present invention.

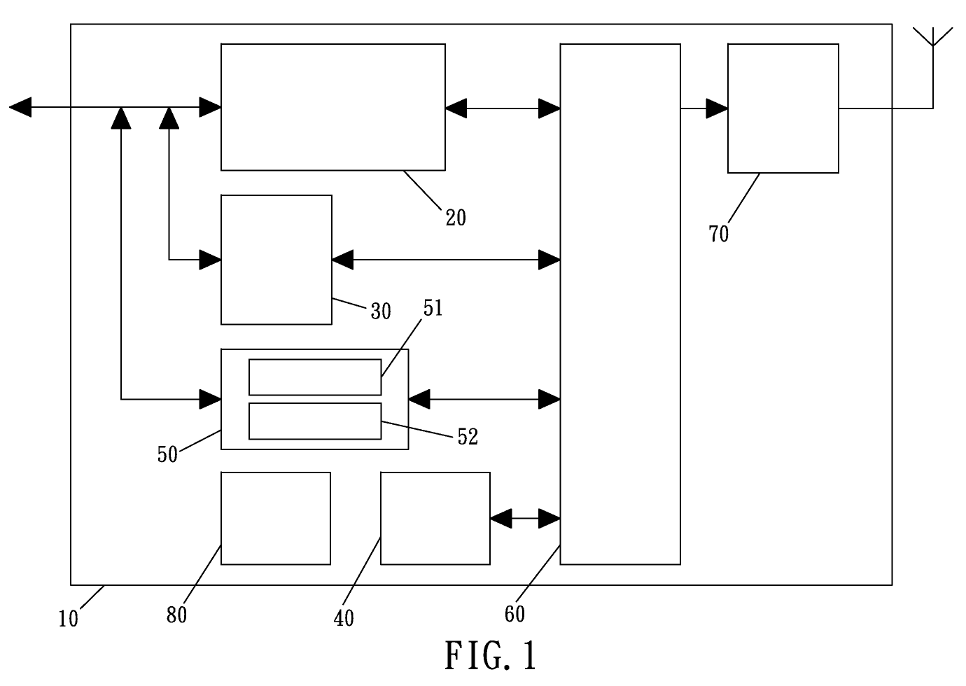

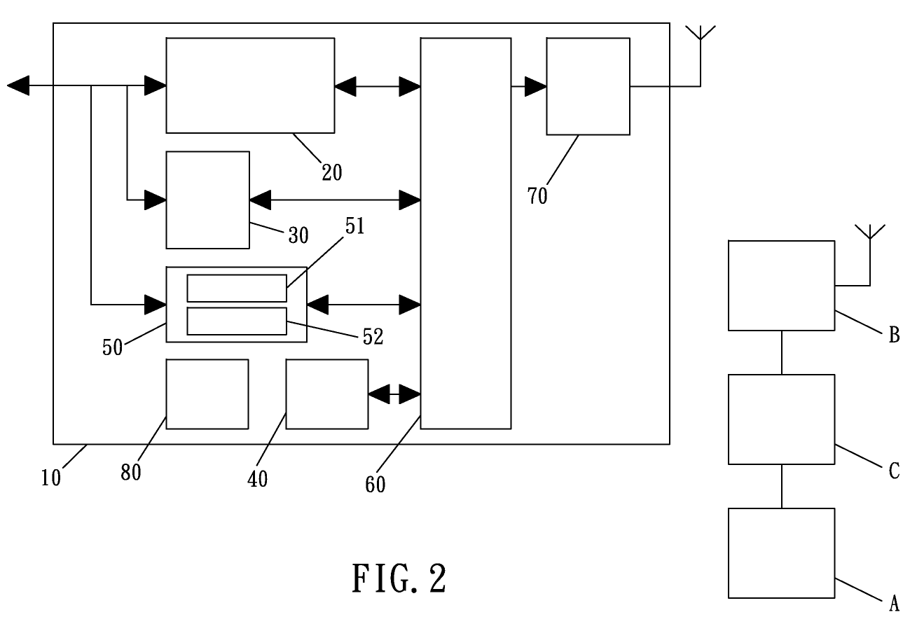

Referring to FIGS. 1 and 2, a phone control device 10 for remotely controlling electric appliance in accordance with the present invention comprises: a ring and echo detector 20, a key decoder 30, a data storage device 40, an on/off hook simulator 50, a single chip 60, a wireless transmitter 70 and a power supply 80.

The ring and echo detector 20 is electrically connected to a phone network to receive phone signal and also connected to the single chip 60 to convert the phone signal into ring signal. The single chip 60 receives the ring signal and records and decides if the number of times of ring signal generated reaches the upper limit.

The key decoder 30 is electrically connected to the phone network to receive the key signal and also connected to the single chip 60.

The data storage device 40 is electrically connected to the single chip 60 and provides comparison signal.

The on/off hook simulator 50 includes an off-hook circuit 51 and an on-hook circuit 52. The off-hook circuit 51 is electrically connected to and driven by the single chip 60. On finding that the number of times of ring signal generated reaches the upper limit, the single chip 60 will make the off-hook circuit 51 simulate an off-hook state. The single chip 60 sends out a first feedback signal to the user via the ring and echo detector 20 and the phone network. After receiving the first feedback signal, the user sends out a control signal through the phone network. The key decoder 30 catches and decodes the control signal corresponding to the first feedback signal via the phone network and sends it to the single chip 60. At this moment, the single chip 60 compares the comparison signal obtained from the data storage device 40 with the control signal obtained by the key decoder 30. If they match, the single chip 60 will send out a second feedback signal to the user through the ring and echo detector 20 and the phone network. After receiving the second feedback signal, the user sends out an on/off driving signal through the phone network. The key decoder 30 catches and decodes the on-off driving signal corresponding to the second feedback signal via the phone network and sends it to the single chip 60. At this moment, the single chip 60 compares the comparison signal obtained from the data storage device 40 with the on/off driving signal obtained by the key decoder 30. If they match, the single chip 60 will control the electric appliance A via the wireless transmitter 70 which is electrically connected to the single chip 60. The electric appliance A should be provided with a wireless receiver B and a switch C. The single chip 60 remotely controls the on/off of the switch C of the electric appliance A via the wireless receiver B. The on-hook circuit 52 of the on/off hook simulator 50 catches the on-hook signal from the user via the phone network and sends it to the single chip 60, so that the single chip 60 stops the driving of the off-hook circuit 51 of the on/off hook simulator 50, and the off-hook circuit 51 simulates an on-hook state.

The power supply 80 supplies the abovementioned components required voltage.

While we have shown and described various embodiments in accordance with the present invention, it is clear to those skilled in the art that further embodiments may be made without departing from the scope of the present invention.

What is claimed is:

1. A phone control device for remotely controlling electric appliance, comprising:
a ring and echo detector electrically connected to a phone network to receive phone signal and also connected to the single chip to convert the phone signal into ring signal, the single chip serving to receive ring signal, record the number of times of the ring signal generated and drive an on/off hook simulator;
a key decoder electrically connected to the phone network and the single chip;
a data storage device electrically connected to the single chip and providing comparison signal;
the on/off hook simulator including an off-hook circuit and an on-hook circuit, the off-hook circuit being electrically connected to and driven by the single chip to simulate an off-hook state, the single chip sending out feedback signals to a user via the ring and echo detector and the phone network, the key decoder catching and decoding control and on/off driving signals corresponding to the feedback signals via the phone network, the single chip comparing the comparison signal obtained from the data storage device with the control signal obtained by the key decoder, the single chip serving to remotely control on/off of an electric appliance by a wireless transmitter which is electrically connected to the single chip, the on-hook circuit catching an on-hook signal via the phone network and sending it to the single chip, and the off-hook circuit simulating an on-hook state;
a power supply supplying the abovementioned components required voltage.

2. The phone control device for remotely controlling electric appliance as claimed in claim 1, wherein the electric appliance is provided with a wireless receiver and a switch, and the single chip remotely controls on/off of the switch of the electric appliance via the wireless receiver.
